(19) United States
(12) Patent Application Publication
(10) Pub. No.: US 2011/0194468 A1
(43) Pub. Date: Aug. 11, 2011

(54) METHOD AND ARCHITECTURE FOR PAIRING GUARD BAND FREQUENCIES FOR EFFECTING GSM, CDMA, UMTS & WCDMA SERVICES

(76) Inventor: Rajiv Mehrotra, New Delhi (IN)

(21) Appl. No.: 12/997,664

(22) PCT Filed: Apr. 22, 2009
(86) PCT No.: PCT/IN09/00244

§ 371 Date: Mar. 17, 2011

(30) Foreign Application Priority Data
Jun. 13, 2008 (IN) 1404/DEL/2008

(51) Int. Cl. H04B 7/00

(52) U.S. Cl. 370/277

(57) ABSTRACT

A method and architecture for pairing of Guard Band Frequencies in PGSM/EGSM 900 MHz and DCS 1800 MHz Bands, as also in US Cellular Bands and US PCS Bands, for effecting duplexed cellular mobile telecommunication services like I-Den, GSM, PGSM, EGSM, CDMA, CDMA 2000, UMTS & WCDMA & any other duplexed use in the guard bands. The method and architecture- of the present invention/innovation leads to two additional interspersed Bands available for exploitation of mobile cellular telecommunication systems, leading to an inherently additional utilization of spectrum that was unutilized in the Art, leading to a near optimal and efficient utilization of a scarce natural resource like spectrum. Further, this present embodiment leads to a balanced link compared to the embodiment in the Art.

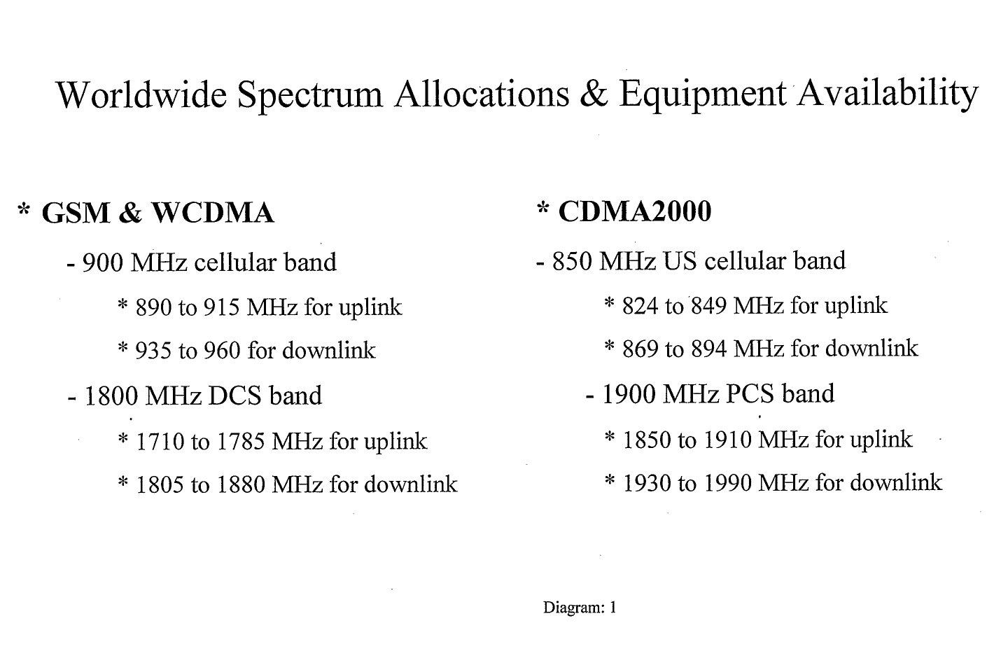

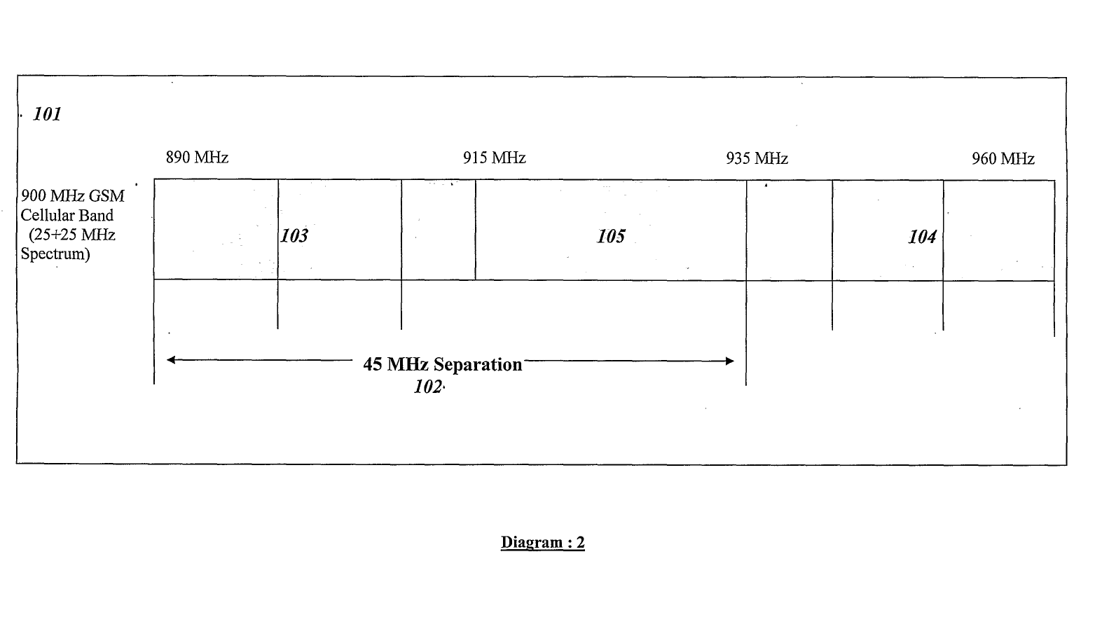

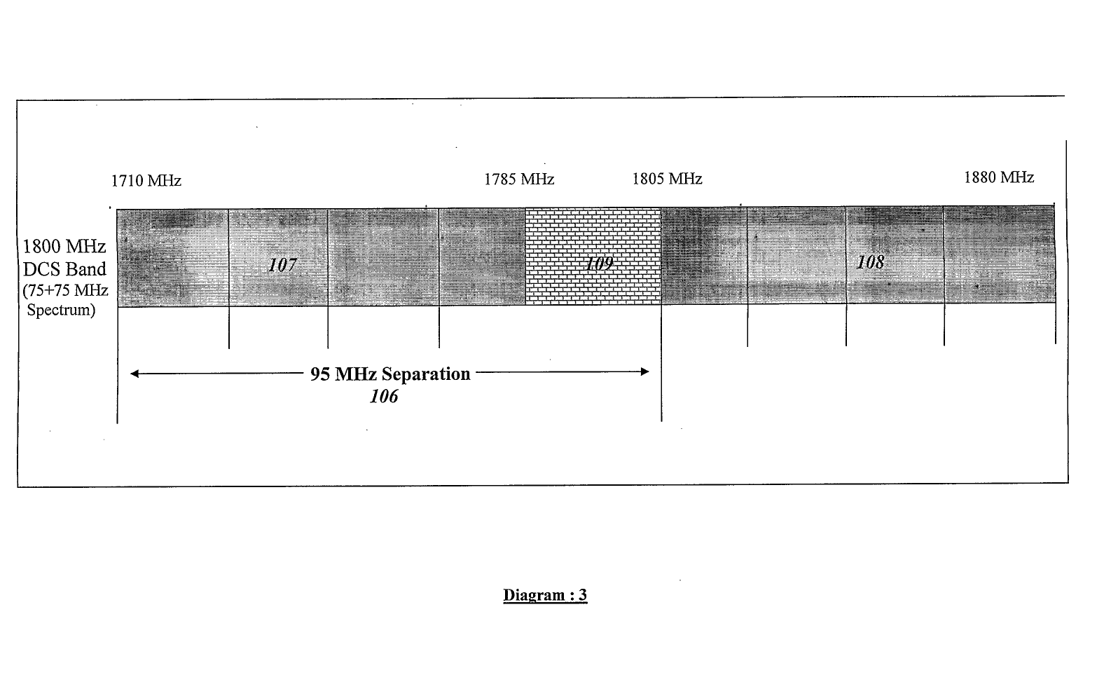

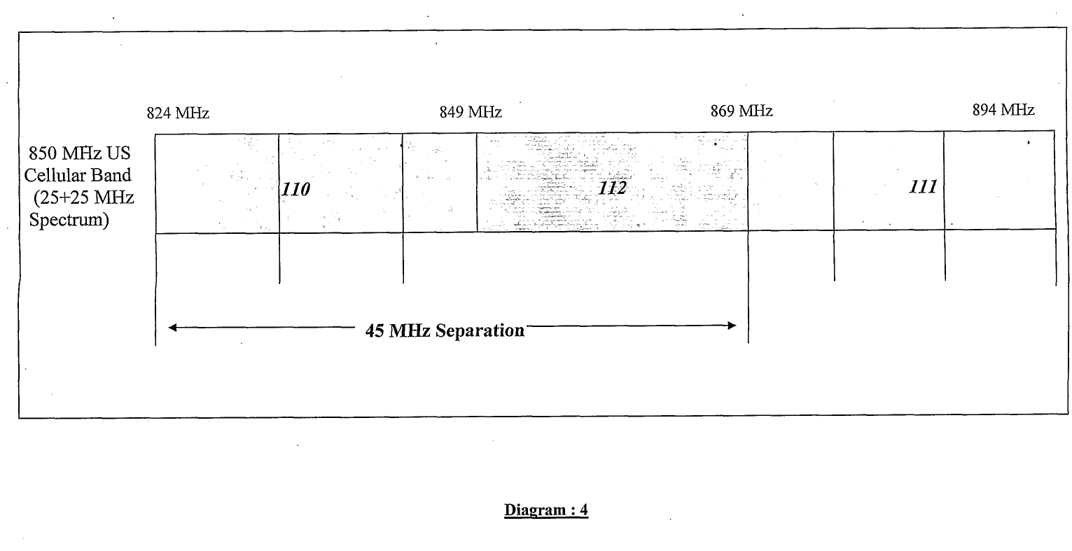

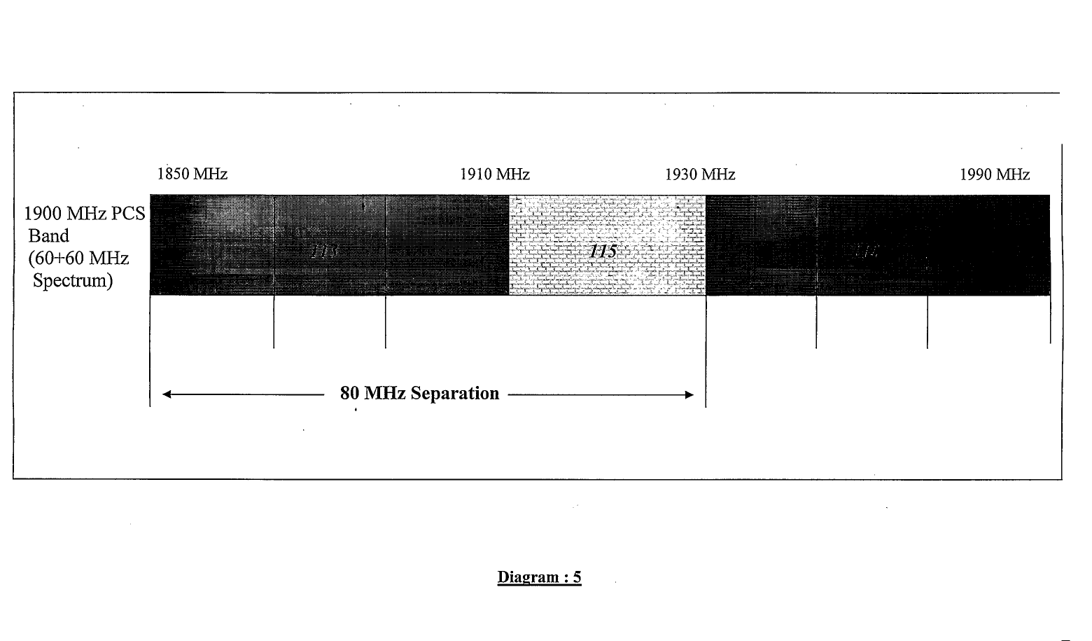

### FIELD OF THE INVENTION

A method and architecture for pairing of Guard Band Frequencies in PGSM/EGSM 900 MHz and DCS 1800 MHz Bands, as also in US Cellular Bands and US PCS Bands, for effecting duplexed cellular mobile telecommunication services like I-Den, GSM, PGSM, EGSM, CDMA, CDMA 2000, UMTS & WCDMA. & any other duplexed use in the guard bands.

### BACKGROUND OF THE INVENTION

Wireless Cellular Telecommunication Technology and use has witnessed unprecedented development and growth in the past decade. One of the basic constraining factors and challenge facing this sector is the availability of effective carrier frequency, generally also known as Spectrum. This is a natural resource, and like all such natural resources, is limited, and needs to be used extremely prudently and efficiently.

Over the years, the world Telecom Regulatory bodies have regulated and allocated various frequency bands, in different regions, for different class of services, essentially based on the kind of technology in use. International Telecommunication Union [‘ITU’] has segregated the world into three regions for the purpose of such allocation. The Indian subcontinent falls into Region 3 for such classification, while Europe and Africa's fall in Region 1 and the Americas fall in Region 2.

The design and availability of Equipment to support various platforms of Cellular Mobile Telecommunications have necessarily had to be compatible with and be based upon such Spectrum Allocations Worldwide. Broadly, the available and emerging platforms from a Spectrum Allocation view point may be segregated into [GSM & WCDMA] and CDMA 2000. The Worldwide Spectrum Allocations for such platforms is placed at Diagram [Table] 1. From an examination of this Table it is seen that the two basic bands of spectrum allocated to GSM/WCDMA are 900 MHz cellular Band and 1800 MHz DCS Band.

Diagram 2 depicts the actual Band Allocation and Deployment for up-linking and Down-linking requirements in a Balanced Duplex Cellular Mobile System [“Duplexed System”] in the 900 MHz GSM cellular Band (25+25 MHz Spectrum). 101 is the actual frequency deployment allocation for the Duplexed System. 102 is the 45 MHz separation between the initial allocated uplink frequency and the initial allocated downlink frequency. 103 is the allocated deployment of 25 MHz for facilitating uplinking requirement, ranging from 890 MHz to 915 MHz. 104 represents the allocated deployment of 25 MHz for the downlink requirement, ranging from 935 MHz to 960 MHz. 105, consisting of 20 MHz ranging from 915 MHz to 935 MHz, is what is technically called the Guard Band [in this case Band RMA].

Historically, the Guard Band has been left unutilized on account of interference issues between the uplink and downlink, as there has to be a gap between the last up link & first down link freq, so that one does not get in to other.

However, as a result, this has led to a tremendous wastage of an international natural resource which in any case itself is in short supply compared to exploding demand of duplexed spectrum.

Diagram 3 depicts the actual Band Allocation and Deployment for up-linking and Down-linking requirements in a Balanced Duplex Cellular Mobile System [“Duplexed System”] in the 1800 MHz DCS Band (75+75 MHz Spectrum). 106 is the 95 MHz separation between the initial allocated uplink frequency and the initial allocated downlink frequency. 107 is the allocated deployment of 75 MHz for facilitating uplink requirement, ranging from 1710 MHz to 1785 MHz. 108 is the allocated deployment of 75 MHz for the downlink requirement, ranging from 1805 MHz to 1880 MHz. 109 is what is technically known as the Guard Band [in this case Band RMB], consisting of 25 MHz of frequency, starting from 1785 MHz to 1805 MHz. This band has also historically been un-deployed, based on interference issues between the uplink and downlink.

Diagram 4 and Diagram 5 depict the CDMA 2000 Spectrum Allocations. In Diagram 4, 110. is the allocated deployment of 25 MHz for facilitating uplinking requirement, ranging from 824 MHz to 849 MHz. 111 represents the allocated deployment of 25 MHz for the downlink requirement, ranging from 869 MHz to 894 MHz. 112, consisting of 20 MHz ranging from 849 MHz to 869 MHz, is what is technically called the Guard Band [in this case Band RMC].

In Diagram 5, 113 is the allocated deployment of 60 MHz for facilitating uplinking requirement, ranging from 1850 MHz to 1910MHz. 114 represents the allocated deployment of 60 MHz for the downlink requirement, ranging from 1930 MHz to 1990 MHz. 115, consisting of 20 MHz ranging from 1910 MHz to 1930 MHz, is what is technically called the Guard Band [in this case Band RMD].

The embodiment in the Art is such that Bands RMA, RMB, RMC and RMD are wholly unutilized. (In some countries, these individual guard band may have been used, but not paired, as claimed by the inventor) This may have been owing to historical reasons of development of the Art, more than technical reasons, and amounts to a sub optimal utilization of such a precious natural resource like spectrum. The inherent inefficiency, leading to an inflated cost of infrastructure and also roll out per subscriber, is the deficiency of the present Art that is sought to be improved by the present invention/innovation.

### DEFINITIONS

“900 MHz GSM Cellular Band: 25 MHz+25 MHz”: From 890 MHz to 915 MHz on the uplink and from 935 MHz to 960 MHz on the downlink, with 915 MHz to 935 MHz as an unutilized Guard Band for eliminating interlink interference.

“1800 MHz DCS Band: 75 MHz+75 MHz”: From 1710 MHz to 1785 MHz on the uplink and from 1805 MHz to 1880 MHz on the downlink, with 1785 MHz to 1805 as an unutilized Guard Band for eliminating interlink interference.

“850 MHz US Cellular Band: 25 MHz+25 MHz”: From 824 MHz to 849 MHz on the uplink and from 869 MHz to 894 MHz on the downlink, with 849 MHz to 869 MHz as an unutilized Guard Band for eliminating interlink interference.

“US PCS Band: 60 MHz+60 MHz”: From 1850 MHz to 1910 MHz on the uplink and from 1930 MHz to 1990 MHz on the downlink, with 1910 MHz to 1930 as an unutilized Guard Band for eliminating interlink interference.

### SUMMARY OF THE INVENTION

A method and architecture for pairing of Guard Band Frequencies in PGSM/EGSM 900 MHz and DCS 1800 MHz Bands, as also separately in US Cellular Bands and US PCS Bands, for effecting duplexed cellular mobile telecommunication services like GSM, CDMA, UMTS & WCDMA. The non utilization of the Bands RMA, RMB, RMC and RMC in the present Art leads to inherent deficiency in and sub optimal utilization of Spectrum.

In embodiment of the invention, the Band RMA is paired with the Band RMB. In this embodiment, the Band RMA (being lower in frequency) is utilized for the uplink, and is paired with the Band RMB on the downlink, which is substantially higher in frequency than the Band RMA (higher by 870 MHz).

In another embodiment of the invention/innovation, the Band RMC (being lower in frequency) is utilized for the uplink, and is paired with the Band RMD on the downlink, which is substantially higher in frequency than the Band RMC (higher by 1061 MHz).

The method and architecture of the present invention/innovation leads to additional utilization of paired duplex spectrum that was unutilized in this fashion in the Art, leading to a near optimal and efficient utilization of a scarce natural resource like spectrum. Further, this present embodiment leads to a balanced link compared to the embodiment in the Art.

### STATEMENT OF THE INVENTION

1 Accordingly, a method for pairing of Guard Band Frequencies in PGSM/EGSM 900 MHz and DCS 1800 MHz Bands, for effecting paired duplexed cellular mobile telecommunication services like I-Den, GSM, PGSM, EGSM, CDMA, CDMA 2000, UMTS & WCDMA & any other paired duplexed use in the guard bands, by pairing the unutilized lower frequency Band RMA for the uplink with the unutilized substantially higher frequency Band RMB on the downlink, leading to a near optimal utilization of the PGSM/EGSM900 MHz and DCS 1800 MHz allocated Bands.
2 Accordingly, a method for pairing of Guard Band Frequencies in US Cellular Bands and US PCS Bands, for effecting paired duplexed cellular mobile telecommunication services like I-Den, GSM, PGSM, EGSM, CDMA, CDMA 2000, UMTS & WCDMA & any other paired duplexed use in the guard bands, by pairing the unutilized lower frequency Band RMC for the uplink with the unutilized substantially higher frequency Band RMD on the downlink, leading to a near optimal utilization of the US Cellular Bands and US PCS allocated Bands.

### DETAILED DESCRIPTION OF THE INVENTION

International Telecommunication Union [‘ITU’] has segregated the world into three regions for the purpose of such allocation. The Indian subcontinent falls into Region 3 for such classification, while Europe and Africas fall in Region 1 and the Americas fall in Region 2.

The design and availability of Equipment to support various platforms of Cellular Mobile Telecommunications have necessarily had to be compatible with and be based upon such Spectrum Allocations Worldwide.

Broadly, the available and emerging platforms from a Spectrum Allocation view point may be segregated into [GSM & WCDMA] and CDMA 2000.

The Worldwide Spectrum Allocations for such platforms is placed at Diagram [Table] 1. From an examination of this Table it is seen that the two basic bands of spectrum allocated to GSM/WCDMA are 900 MHz cellular Band and 1800 MHz DCS Band.

Diagram 2 depicts the actual Band Allocation and Deployment for up-linking and Down-linking requirements in a Balanced Duplex Cellular Mobile System [“Duplexed System”] in the 900 MHz GSM cellular Band (25+25 MHz Spectrum). 101. is the actual frequency deployment allocation for the Duplexed System. 102 is the 45 MHz separation between the initial allocated uplink frequency and the initial allocated downlink frequency. 103 is the allocated deployment of 25 MHz for facilitating uplinking requirement, ranging from 890 MHz to 915 MHz. 104 represents the allocated deployment of 25 MHz for the downlink requirement, ranging from 935 MHz to 960 MHz. 105, consisting of 20 MHz ranging from 915 MHz to 935 MHz, is what is technically called the Guard Band [in this case Band RMA]. Historically, the Guard Band has been left unutilized on account of interference issues between the uplink and downlink. However, as a result, this has led to a tremendous wastage of an international natural resource which in any case itself in short supply compared to exploding demand.

Diagram 3 depicts the actual Band Allocation and Deployment for up-linking and Down-linking requirements in a Balanced Duplex Cellular Mobile System [“Duplexed System”] in the 1800 MHz DCS Band (75+75 MHz Spectrum). 106 is the 95 MHz separation between the initial allocated uplink frequency and the initial allocated downlink frequency. 107 is the allocated deployment of 75 MHz for facilitating uplink requirement, ranging from 1710 MHz to 1785 MHz. 108 is the allocated deployment of 75 MHz for the downlink requirement, ranging from 1805 MHz to 1880 MHz. 109 is what is technically known as the Guard Band [in this case Band RMB], consisting of 25 MHz of frequency, starting from 1785 MHz to 1805 MHz. This band has also historically been un-deployed, based on interference issues between the uplink and downlink.

Diagram 4 and Diagram 5 depict the CDMA 2000 Spectrum Allocations. In Diagram 4, 110 is the allocated deployment of 25 MHz for facilitating uplinking requirement, ranging from 824 MHz to 849 MHz. 111 represents the allocated deployment of 25 MHz for the downlink requirement, ranging from 869 MHz to 894 MHz. 112, consisting of 20 MHz ranging from 849 MHz to 869 MHz, is what is technically called the Guard Band [in this case Band RMC].

In Diagram 5, 113 is the allocated deployment of 60 MHz for facilitating uplinking requirement, ranging from 1850 MHz to 1910 MHz. 114 represents the allocated deployment of 60 MHz for the downlink requirement, ranging from 1930 MHz to 1990 MHz. 115, consisting of 20 MHz ranging from 1910 MHz to 1930 MHz, is what is technically called the Guard Band [in this case Band RMD].

The embodiment in the Art is such that Bands RMA, RMB, RMC and RMD are wholly unutilized. This may have been owing to historical reasons of development of the Art, more than technical reasons, and amounts to a sub optimal utilization of such a precious natural resource like spectrum. The inherent inefficiency, leading to an inflated cost of infrastructure and also roll out per subscriber, is the deficiency of the present Art that is sought to be improved by the present invention/innovation.

In a preferred embodiment of the invention, the Band RMA is paired with the Band RMB. for affecting an interspersed mobile cellular telecommunication system. In this embodiment, the Band RMA (being lower in frequency) is utilized for the uplink, and is paired with the Band RMB on the downlink, which is substantially higher in frequency than the Band RMA (higher by 850 MHz). In another preferred embodiment of the invention/innovation, the Band RMC (being lower in frequency) is utilized for the uplink, and is paired with the Band RMD on the downlink, which is substantially higher in frequency than the Band RMA (higher by 850 MHz). The method and architecture of the present invention/innovation leads to two additional interspersed Bands available for exploitation of mobile cellular telecommunication systems, leading to an inherently additional utilization of spectrum that was unutilized in the Art, leading to a near optimal and efficient utilization of a scarce natural resource like spectrum. Further, this present embodiment leads to a balanced link compared to the embodiment in the Art.

Further, in one embodiment, the present invention leads to an improved interlink balance between the uplink and the down link, leading to an improved efficiency of the spectrum utilization and improved efficiency as regards the ability of the system to support an improved number of cellular hand held devices per unit of spectrum, as well as lower costs of roll out and running costs of the mobile cellular telecommunication system.

We claim:

1. A method for pairing of Guard Band Frequencies in PGSM/EGSM 900 MHz and DCS 1800 MHz Bands, for effecting duplexed cellular Mobile telecommunication services like I-Den, GSM, PGSM, EGSM, CDMA, CDMA 2000, UMTS & WCDMA. & any other duplexed use in the guard bands, by pairing the unutilized lower frequency Band RMA for the uplink with the unutilized substantially higher frequency Band RMB on the downlink, leading to a near optimal utilization of the PGSM/EGSM900 MHz and DCS 1800 MHz allocated Bands.

2. A method for pairing of Guard Band Frequencies in US Cellular Bands and US PCS Bands, for effecting duplexed cellular mobile telecommunication services like I-Den, GSM, PGSM, EGSM, CDMA, CDMA 2000, UMTS & WCDMA. & any other duplexed use in the guard bands., by pairing the unutilized lower frequency Band RMC for the uplink with the unutilized substantially higher frequency Band RMD on the downlink, leading to a near optimal utilization of the US Cellular Bands and US PCS allocated Bands.

3. A method to improve the inter link balance between the uplink and the downlink in a mobile cellular telecommunication system.

4. An architecture to improve the inter link balance between the uplink and downlink in a mobile cellular telecommunication system like I-Den, GSM, PGSM, EGSM, CDMA, CDMA 2000, UMTS & WCDMA. & any other paired duplexed use in the guard bands.
